(19) United States
(12) Patent Application Publication
(10) Pub. No.: US 2026/0356196 A1
(43) Pub. Date: Nov. 12, 2026

(54) METHOD AND SYSTEM FOR ASSISTED DRIVING

(71) Applicant: Nanning FuLian FuGui Precision Industrial Co., Ltd., Nanning (CN)

(72) Inventor: Yu-Hu YAN, New Taipei (TW)

(21) Appl. No.: 19/089,288

(22) Filed: Mar. 25, 2025

(51) Int. Cl. B60K 35/231; G02B 27/01

(52) U.S. Cl. CPC B60K 35/231; G02B 27/0172; B60K 2360/176; G02B 2027/0178

(57) ABSTRACT

An assisted driving method and system operating in an in-vehicle system and smart glasses. The in-vehicle system first obtains a vehicle cabin model and a field-of-view image from the smart glasses. Then, feature point matching is performed to compare the field-of-view image with the vehicle cabin model, determining the spatial position information for the assisted driving image. Subsequently, the in-vehicle system generates the assisted driving image based on the field-of-view image, the vehicle cabin model, and the spatial position information, and transmits the image to the smart glasses. This allows the driver to obtain more intuitive assisted driving information through the smart glasses, enhancing driving safety and experience.

### FIELD

A method and a system for assisted driving.

### BACKGROUND

As vehicle technology continues to evolve, drivers expect improved energy efficiency, and also enhanced safety protection. In addition to advanced active safety technologies, the application of panoramic video systems is a further step towards the vision of zero accidents.

However, even though vehicles are increasingly well-quipped, the structural design of the vehicle can still impact the field of vision of the driver. For example, an A-pillar may block the line of sight when driving and turning, or create a dead zone when reversing, thereby potentially lead to accidents.

### BRIEF DESCRIPTION OF THE DRAWINGS

Implementations of the present technology will now be described, by way of example only, with reference to the attached figures, wherein:

FIG. 1 is a schematic diagram of an architecture of an assisted driving system according to one embodiment of the present disclosure.

FIG. 2 is a flow chart of an assisted driving method according to one embodiment of the present disclosure.

FIG. 3 is a flow chart of an assisted driving method according to another embodiment of the present disclosure.

FIG. 4 is a flow chart of an assisted driving method according to another embodiment of the present disclosure.

### DETAILED DESCRIPTION

It should be understood that the detailed description and specific examples, while indicating exemplary embodiments, are projected for purposes of illustration only and are not projected to limit the scope of the claims.

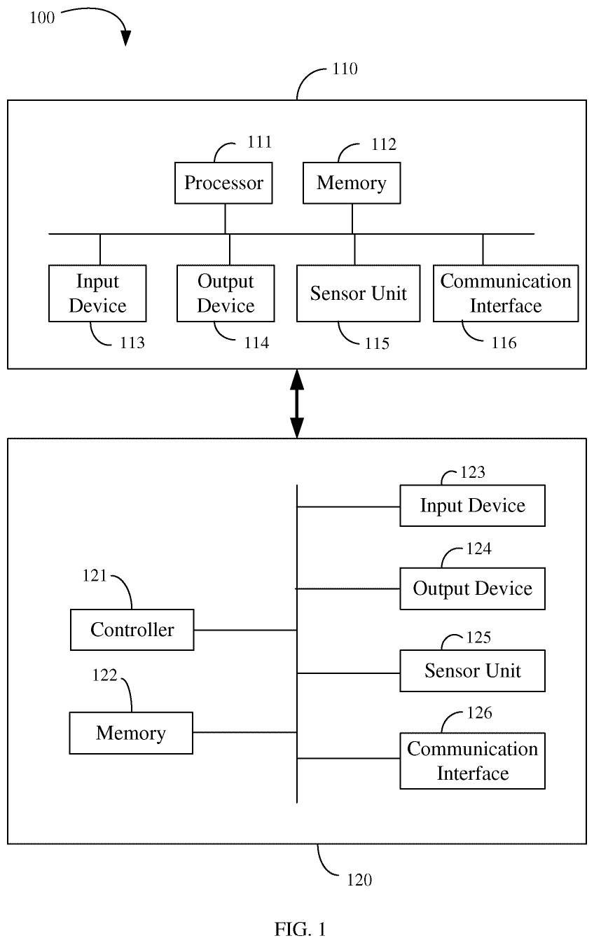

FIG. 1 is a schematic diagram of an architecture of an assisted driving system. The system 100 comprises smart glasses 110 and an in-vehicle system 120, wherein the smart glasses 110 are worn by the driver of the vehicle, the in-vehicle system 120 is mounted on the vehicle, and the smart glasses 110 and the in-vehicle system 120 can communicate over any wired network, wireless network, or combination thereof. The in-vehicle system 120 can be used in, but is not limited to, autonomous vehicles, semi-autonomous vehicles, and non-autonomous vehicles. It will be appreciated by those skilled in the art that the smart glasses 110 and the in-vehicle system 120 illustrated in FIG. 1 can also include more or fewer components that illustrated, or a combination of some of their components, or a different set components.

The smart glasses 110 include, but are not limited to, mixed reality glasses, augmented reality glasses, and virtual reality glasses.

The smart glasses 110 include a processor 111, a memory 112, an input device 113, an output device 114, a sensor unit 115, and a communication interface 116.

The processor 111 can comprise one or more processing cores. The processor 111 connects various components with the smart glasses 110 using various interfaces, internal buses, and external buses to perform various functions and process data of the smart glasses 110 by running or executing sets of instructions, computer programs, or codes stored in the memory 112 and by retrieving data stored in the memory 112.

The input device 113 is configured to provide inputs to an user as well as to generate signal inputs related to function control, including but not limited to a camera device, a microphone, and the like.

The output device 114 can include, for example, a display, a speaker, a vibrator, and other devices. The display can include an imaging screen to reflect the image projection source into the user's eye, and the display can also direct the image projection source into the user's eye using light waves.

The sensor unit 115 is configured to obtain motion parameters of the smart glasses 110 to determine a positional attitude of the smart glasses 110. For example, the sensor unit 115 can include an inertial measurement unit (IMU) sensor (including accelerometers and gyroscopes) to obtain three-degree-freedom attitude data of the smart glasses 110 as the motion parameters of the smart glasses 110. Based on the three-degree-of-freedom attitude angle-related information, the rotation direction and the rotation angle of the smart glasses 110 can be determined, while the translational distance in various rotation directions can be determined based on the three-degree-of-freedom axial acceleration information.

The communication interface 116 is configured to communicate with external devices or systems, such as the in-vehicle system 120 in FIG. 1. The communication interface 116 can optionally include standard wired interfaces or wireless interfaces, such as a Bluetooth interface or a Wi-Fi interface.

The in-vehicle system 120 includes a controller 121, a memory 122, an input device 123, an output device 124, a sensor unit 125, and a communication interface 126.

The controller 121 is configured to serve as the control center of the in-vehicle system 120. It is connected to various components of the in-vehicle system via different interfaces and circuits and executes various functions and data processing tasks by running instruction sets, computer programs, or codes stored in the memory 122, as well as retrieving data stored in the memory 122. This enables overall vehicle control and information processing.

In one embodiment, the controller 121 can include one or more processing units, such as a microcontroller or an electronic control unit. For example, the controller 121 can include a first microcontroller (not shown in FIG. 1) configured to process and control data and functions related to an advanced driver assistance system, a second microcontroller (not shown in FIG. 1) configured to process and control data and functions related to autonomous driving, and a third microcontroller (not shown in FIG. 1) configured to control braking mechanisms of the vehicle body. The braking mechanisms of the vehicle body can include components such as a chassis motor controller, a seat controller, an air conditioning controller, a battery controller, a door and window controller, and a lighting controller.

The memory 122 is configured to store computer programs and various types of data. The memory 122 includes a program storage area and a data storage area, where the program storage area is configured to store an operating system, at least one application required for specific functions, etc., while the data storage area is configured to store data or information generated based on the usage of the in-vehicle system 120.

The input device 123 is configured to receive input signals and user input information. For example, it can include a microphone for receiving voice input or a touch display screen for displaying information to the driver or passengers and/or receiving touch input.

The output device 124 is configured to present data and information. For examples, the output device 124 can include monitors, touchscreens, television screens, head-up displays, other types of display devices or combinations thereof, speakers, and dashboards.

The sensor unit 125 can include one or more sensors configured to obtain sensing data from one or more sensors. These sensors can be positioned in the interior and/or exterior areas of the vehicle. Examples of such sensors include position sensors, radar sensors, ultrasonic sensors, LiDAR sensors, IMU sensors, surround-view cameras, infrared cameras, steering sensors, vibration sensors, and speed sensors.

The communication interface 126 is configured to communicate with external devices over a network. The communication interface 126 can receive data and instructions from external devices as well as transmit data, instructions, and information to these external devices. In one example, the external devices can include electronic devices such as mobile phones, tablet computers, and the smart glasses 110.

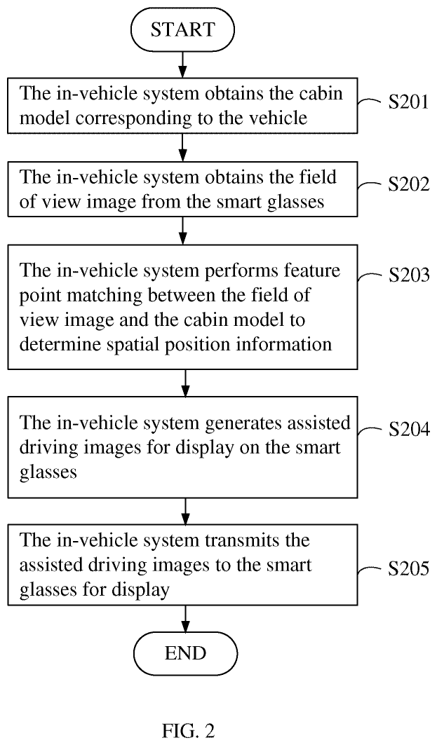

FIG. 2 is a flow chart of an assisted driving method. The method can be executed by the smart glasses and the in-vehicle system within the assisted driving system. In one embodiment, before executing the assisted driving method, the smart glasses and the in-vehicle system can first establish a connection and perform pairing via Bluetooth.

Step S201, the in-vehicle system obtains the cabin model corresponding to the vehicle.

In one embodiment, the cabin model can be a 3D cabin model obtained through three-dimensional modeling of the cabin, or it can be a cabin model generated by capturing images of the cabin and stitching the acquired images together. For example, multiple images of the vehicle's interior space can be captured from various angles, and these images can then be synthesized into an animated cabin model. This cabin model can be pre-built and stored in the memory of the in-vehicle system.

Step S202, the in-vehicle system obtains a field-of-view image of the smart glasses.

In one embodiment, the field-of-view image of the driver wearing the smart glasses is captured using the camera unit of the smart glasses and transmitted to the in-vehicle system via the communication interface, such as Wi-Fi.

Step S203, the in-vehicle system performs feature point matching between the field-of-view image and the cabin model to determine the spatial position information for generating an assisted driving image.

In one embodiment, algorithms such as SIFT, ORB, and SURF can be used for image feature extraction to match key points between the field-of-view image and the cabin model, thereby determining the spatial position information for mapping the generated assisted driving image onto the cabin model.

Step S204, the in-vehicle system generates the assisted driving image for display on the smart glasses based on the field-of-view image, the cabin model, and the spatial position information.

In one embodiment, the in-vehicle system can perform neural network-based computations. Once trained, the neural network can recognize at least one region of the cabin model. For example, the neural network can be used to identify structural regions of the vehicle body and glass material regions within the cabin model. The structural regions can include the A-pillar, B-pillar, or C-pillar, which typically obstruct the view of the outside environment, while the glass material regions, such as windows, windshields, or rearview mirrors, usually allow external visibility.

By using the neural network to recognize at least one region of the cabin model, the in-vehicle system essentially performs localization of these regions. As a result, the in-vehicle system can determine whether the driver's field of view includes any structural regions that can obstruct vision. If the driver's field of view includes such obstructive structural regions (e.g., the A-pillar, B-pillar, or C-pillar), the system retrieves the external image corresponding to the obstructed area based on the spatial position information and generates an assisted driving image that includes a perspective view of the obstructed structural region. In one embodiment, a camera may be located in an appropriate position outside the vehicle to obtain the external image of the vehicle.

Specifically, the in-vehicle system processes both the field-of-view image and the external image so that the external image corresponding to the obstructive structural region is overlaid onto the structural region within the field-of-view image, thereby achieving a perspective effect.

Step S205, the in-vehicle system transmits the assisted driving image to the smart glasses for display.

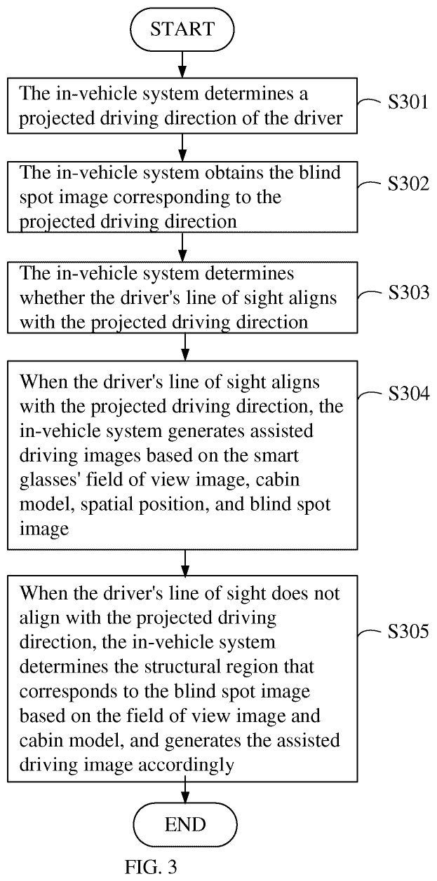

FIG. 3 is a flow chart of the assisted driving method in another embodiment. This method can be executed by the smart glasses and the in-vehicle system in the assisted driving system. Before executing the assisted driving method, the smart glasses and the in-vehicle system can first establish a connection and perform pairing via Bluetooth.

Step S301, the in-vehicle system determines a projected driving direction of the driver.

In one embodiment, the in-vehicle system can determine the projected driving direction of the driver based on gear position information, gear shift information, and steering wheel rotation angle. The gear shift information includes switching from the parking gear to the drive gear, switching from the drive gear to the reverse gear, and switching from the parking gear to the reverse gear. Specifically, switching from the parking gear to the drive gear indicates that the vehicle transitions from a stationary state to moving forward, switching from the drive gear to the reverse gear indicates that the vehicle transitions from moving forward to moving backward, and switching from the parking gear to the reverse gear indicates that the vehicle transitions from a stationary state to moving backward. The in-vehicle system can integrate the gear position information, gear shift information, and steering wheel rotation angle to compute the vehicle's azimuth angle, thereby determining the driver's projected driving direction.

In another embodiment, the in-vehicle system can determine the projected driving direction of the driver based on the status of the turn signals and the wheel rotation direction.

In another embodiment, the in-vehicle system can determine the projected driving direction of the driver based on surrounding images captured by the surround-view cameras. For example, lane line analysis of surrounding images can be used to determine whether the vehicle is changing lanes or turning left or right. Additionally, by comparing the relative position changes between the vehicle and intersection signs or other vehicles, the in-vehicle system can determine the driver's projected driving direction.

Step S302, the in-vehicle system obtains the blind-spot image corresponding to the projected driving direction.

Step S303, the in-vehicle system determines whether the driver's line of sight matches the projected driving direction.

In one embodiment, the in-vehicle system can determine the driver's line of sight by comparing the field-of-view image from the smart glasses with the vehicle cabin model and identifying the center point of the field-of-view image.

Step S304, when the driver's line of sight matches the projected driving direction, the in-vehicle system generates an assisted driving image based on the field-of-view image of the smart glasses, the vehicle cabin model, the spatial position, and the blind-spot image. The assisted driving image includes a perspective image of the vehicle's structural region corresponding to the blind-spot image.

In one embodiment, the in-vehicle system can generate the perspective image by simultaneously comparing feature points of the field-of-view image with those of the vehicle cabin model and the blind-spot image.

For example, when the in-vehicle system determines that the vehicle is transitioning from a stationary state to moving forward, it can obtain the front blind-spot image and generate an assisted driving image that includes a perspective view of the lower edge of the windshield and the dashboard.

Step S305, when the driver's line of sight does not match the projected driving direction, the in-vehicle system determines the vehicle structural region where the blind-spot image should be applied based on the field-of-view image and the vehicle cabin model to generate the assisted driving image.

For example, when the in-vehicle system determines that the vehicle is transitioning from moving forward to moving backward, the driver would typically focus on the rearview mirror rather than looking directly backward while reversing. In this case, the field-of-view image captured by the smart glasses would include the rearview mirror. The in-vehicle system can obtain the rear blind-spot image and overlay it onto the position of the rearview mirror in the field-of-view image to generate the assisted driving image.

In one embodiment, the in-vehicle system can also integrate an advanced driver assistance system (ADAS) to highlight objects near the vehicle within the assisted driving image using alert boxes, thereby reminding the driver to stay attentive.

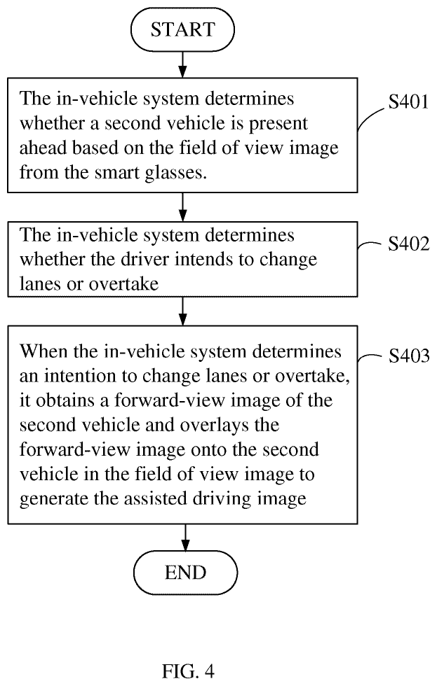

FIG. 4 is a flow chart of the assisted driving method in another embodiment. This method can be executed by the smart glasses and the in-vehicle system within the assisted driving system. Before executing the assisted driving method, the smart glasses and the in-vehicle system may first establish a connection and perform pairing via Bluetooth.

Step S401, the in-vehicle system determines whether a second vehicle is present ahead based on the field-of-view image of the smart glasses.

Step S402, the in-vehicle system determines whether the driver intends to change lanes or overtake.

In one embodiment, the in-vehicle system can comprehensively determine whether the driver intends to change lanes or overtake based on the lane analysis results from the surrounding image, the status of the turn signals, and whether there is a change in vehicle speed.

Step S403, when the in-vehicle system determines that there is an intention to change lanes or overtake, the in-vehicle system obtains the front-view image of the second vehicle and overlays the front-view image onto the position of the second vehicle in the field-of-view image to generate an assisted driving image.

In one embodiment, the in-vehicle system can obtain the front-view image of the second vehicle via vehicle-to-vehicle communication or the Internet of Vehicles (IoV).

In summary, the assisted driving method and system allow the driver, wearing smart glasses, to view assisted driving images with a perspective effect, thereby enhancing driving safety.

It will be apparent to those skilled in the art that various modifications and variations can be made to the disclosure without departing from the scope or spirit of the claims. In view of the foregoing, it is intended that the present disclosure covers modifications and variations, provided they fall within the scope of the following claims and their equivalents.

What is claimed is:

1. An assisted driving method executed in an in-vehicle system and smart glasses, the method comprising:
the in-vehicle system obtaining a vehicle cabin model corresponding to a vehicle operated by the in-vehicle system and a field-of-view image from the smart glasses;
the in-vehicle system performing feature point matching between the field-of-view image and the vehicle cabin model to determine spatial position information;
the in-vehicle system generating an assisted driving image based on the field-of-view image, the vehicle cabin model, and the spatial position information; and
the in-vehicle system transmitting the assisted driving image to the smart glasses, and enabling the smart glasses to display the assisted driving image.

2. The assisted driving method of claim 1, wherein the vehicle cabin model includes at least one structural region of a body of the vehicle and at least one glass material region.

3. The assisted driving method of claim 2, wherein the generating the assisted driving image based on the field-of-view image, the vehicle cabin model, and the spatial position information further comprises:
the in-vehicle system determining whether a field of view of a driver of the vehicle includes the at least one structural region based on the field-of-view image and the vehicle cabin model; and
the in-vehicle system obtaining an external image corresponding to the at least one structural region based on the spatial position information to generate the assisted driving image when the field of view of the driver is determined including the at least one structural region.

4. The assisted driving method of claim 3, wherein the obtaining an external vehicle image corresponding to the at least one structural region based on the spatial position information to generate the assisted driving image further comprises:
the in-vehicle system overlaying the external image corresponding to the at least one structural region onto a corresponding structural region in the field-of-view image to obtain a perspective effect.

5. The assisted driving method of claim 1, further comprising:
the in-vehicle system determining a projected driving direction of a driver of the vehicle;
the in-vehicle system obtaining a blind-spot image corresponding to the projected driving direction;
the in-vehicle system determining whether a line of sight of the driver is consistent with the projected driving direction;
the in-vehicle system generating the assisted driving image based on the field-of-view image of the smart glasses, the vehicle cabin model, the spatial position information, and the blind-spot image, wherein the assisted driving image includes a perspective image of the at least one structural region corresponding to the blind-spot image when the line of sight is determined consistent with the projected driving direction; and
the in-vehicle system determines the at least one structural region where the blind-spot image is overlaid based on the field-of-view image and the vehicle cabin model to generate the assisted driving image when the line of sight is determined not consistent with the projected driving direction.

6. The assisted driving method of claim 1, further comprising:
the in-vehicle system detecting objects approaching the vehicle via an advanced driver assistance system;
the in-vehicle system adding a prompt box in the assisted driving image comprising the detected objects to alert a driver of the vehicle.

7. The assisted driving method of claim 1, further comprising:
the in-vehicle system determining whether a second vehicle is present and ahead based on the field-of-view image from the smart glasses;
the in-vehicle system determining whether the vehicle operated by the in-vehicle system is projected to change lanes or overtake the second vehicle;
the in-vehicle system obtaining a front-view image of the second vehicle and overlaying the front-view image onto a position of the second vehicle in the field-of-view image to generate the assisted driving image when the vehicle is determined projected to change lanes or overtake the second vehicle.

8. The assisted driving method of claim 2, wherein the at least one glass material region of the vehicle cabin model includes windows, windshields, and rearview mirrors.

9. The assisted driving method of claim 2, wherein the at least one structural region of the vehicle cabin model includes A-pillars, B-pillars, and C-pillars.

10. An assisted driving system comprising:
an in-vehicle system; and
smart glasses, wherein the in-vehicle system includes a non-transitory memory storage storing processor-executable instructions and a controller coupled to the non-transitory memory storage to receive the processor-executable instructions, wherein, upon execution of the controller executable instructions, the controller:
obtaining a vehicle cabin model corresponding to a vehicle operated by the in-vehicle system and a field-of-view image from the smart glasses;
performing feature point matching between the field-of-view image and the vehicle cabin model to determine spatial position information;
generating an assisted driving image based on the field-of-view image, the vehicle cabin model, and the spatial position information; and
transmitting the assisted driving image to the smart glasses, and enabling the smart glasses to display the assisted driving image.
